(19) United States
(12) Patent Application Publication
(10) Pub. No.: US 2012/0070607 A1
(43) Pub. Date: Mar. 22, 2012

(54) IMPACT-RESISTIVE DISPLAY DEVICE

(75) Inventors: Chiao-Kuen YU, Hsin-Chu (TW); Yung-Chih LIU, Hsin-Chu (TW); Su LO, Hsin-Chu (TW)

(73) Assignee: AU OPTRONICS CORP., HSINCHU (TW)

(21) Appl. No.: 13/227,564

(22) Filed: Sep. 8, 2011

(30) Foreign Application Priority Data
Sep. 16, 2010 (TW) 099131458

(51) Int. Cl. B32B 3/02; B32B 7/02

(52) U.S. Cl. 428/77; 428/192

(57) ABSTRACT

A display device includes a display panel, a polarizing sheet, a transparent adhesive layer and a transparent protective layer. The polarizing sheet is attached onto a surface of the display panel and has a cut corner. The transparent adhesive layer covers a surface of the polarizing sheet distal from the display panel. The transparent protective layer is attached to the polarizing sheet through the transparent adhesive layer and completely covers the polarizing sheet. Area of the polarizing sheet is smaller than that of the transparent protective plate.

### FIELD OF THE INVENTION

The present invention relates to a display device, and more particularly to a display device with improved impact resistance.

### BACKGROUND OF THE INVENTION

Touch sensitive display devices are widely used in various portable electronic devices, such as smart phones or tablet computers. A portable electronic device is likely to be dropped accidentally due to its light and small features. Therefore in the process of making a touch sensitive display device, the touch sensitive display device is commonly subjected to a drop-protective test to ensure the touch sensitive display device has high-enough impact resistance.

FIG. 1A is a schematic view of a touch sensitive display device, in which a corner portion 18 of the touch sensitive display device impacting on a plane 19 while dropping is shown.

FIG. 1B is a schematic partial cross-sectional view of the touch sensitive display device, in which a phenomenon occurs due to dropping is shown. As shown, the touch sensitive display device includes a display panel 10, a polarizing sheet 11 attached onto a surface of the display panel 10, a transparent adhesive layer 12 covering a surface of the polarizing sheet 11 and a transparent protective layer 13 covering a surface of the transparent adhesive layer 12. A distorting force generated from deformation of the transparent protective layer 13 would make the transparent adhesive layer 12 and the polarizing sheet 11 separated from each other instantaneously. Consequently, air may enter so as to introduce air bubbles 14 in between the transparent protective layer 13 and the polarizing sheet 11.

What is needed, therefore, is a display device that can overcome the above-mentioned shortcomings.

### SUMMARY OF THE INVENTION

Therefore, the object of the present invention is to provide a display device with improved impact resistance.

The present invention provides a display device, which includes a display panel, a polarizing sheet, a transparent adhesive layer and a transparent protective layer. The polarizing sheet is attached onto a surface of the display panel. The transparent adhesive layer overlies a surface of the polarizing sheet opposite to the surface of the display panel. The transparent protective layer is attached to the polarizing sheet through the transparent adhesive layer. Area of the polarizing sheet is smaller than that of the transparent protective plate. The polarizing sheet has at least one cut corner, and the polarizing sheet is completely covered by the transparent protective layer.

In an embodiment of the present invention, the display panel can be a touch sensitive display panel.

In an embodiment of the present invention, the transparent adhesive layer can be made of optical clear adhesion.

In an embodiment of the present invention, the transparent protective layer can be made of a glass sheet or an acrylic sheet.

In an embodiment of the present invention, the display panel has a display region and a peripheral region surrounding the display region, and the cut corner of the polarizing sheet spatially corresponds to a corner of the peripheral region, and the display region is completely covered by the polarizing sheet.

In an embodiment of the present invention, the display panel includes a bottom substrate and an upper substrate disposed on the bottom substrate, the corner portion located on the upper substrate.

In an embodiment of the present invention, the cut corner has a slanting side wall or is rounded.

In an embodiment, a corner portion of the transparent protective layer, corresponding to the cut corner, protrudes from an outer edge of the cut corner.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A is a schematic view of a dropping touch sensitive display device;

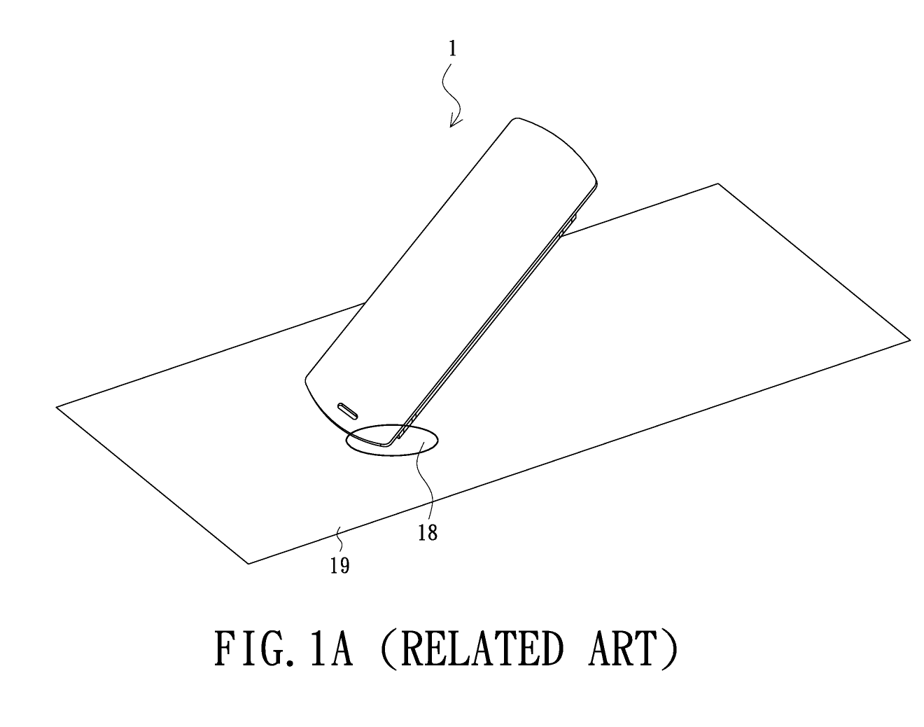

FIG. 1B is a schematic partial cross-sectional view of the dropped touch sensitive display device of FIG. 1A;

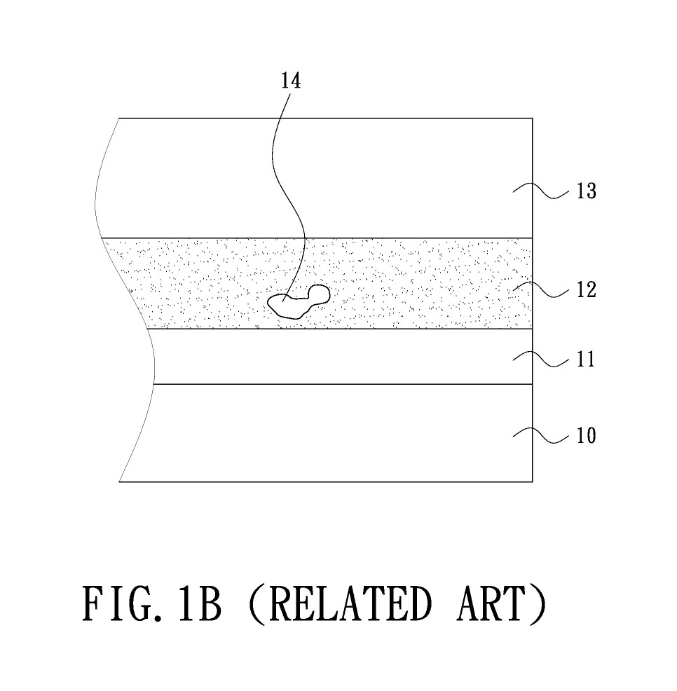

FIG. 2 is a schematic view of a conventional touch sensitive display device;

FIG. 3A is a schematic cross-sectional view of a display device according to an embodiment of the present invention;

FIG. 3B is a schematic top view of the display device as shown in FIG. 3A in an embodiment of the present invention;

FIG. 3C is a schematic top view of the display device as shown in FIG. 3A in another embodiment of the present invention; and

FIG. 3D is a schematic cross-sectional view of a display device according to another embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

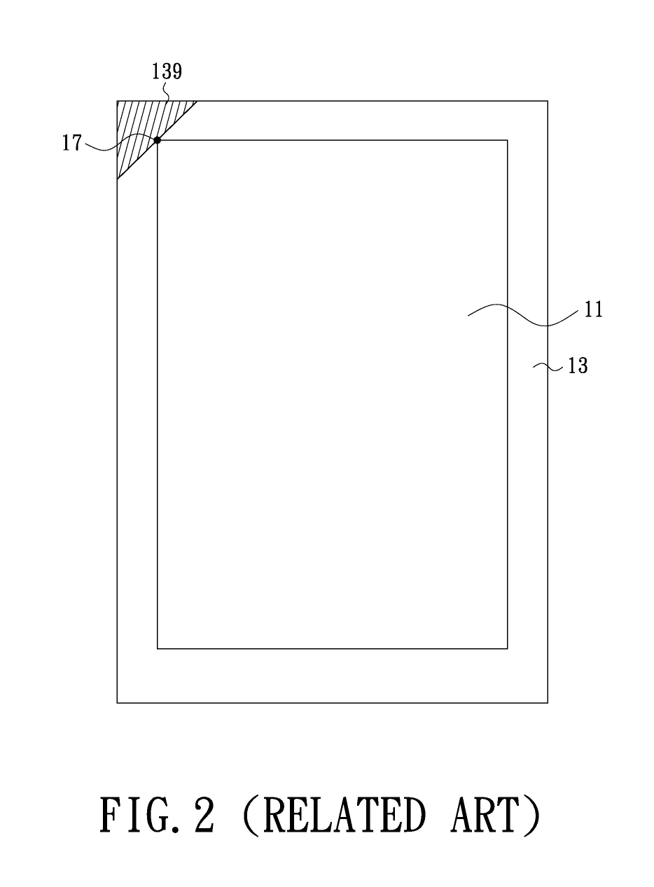

In a conventional touch sensitive display device as shown in FIG. 2, if the touch sensitive display device is dropped so as to result in impact in a deformation region 139 of the transparent protective layer 13, the impact will extend to a corner of the polarizing sheet 11, and the peel force will be concentrated at an end point 17. As a result, it is likely that the polarizing sheet 11 becomes separated from the transparent protective layer 13.

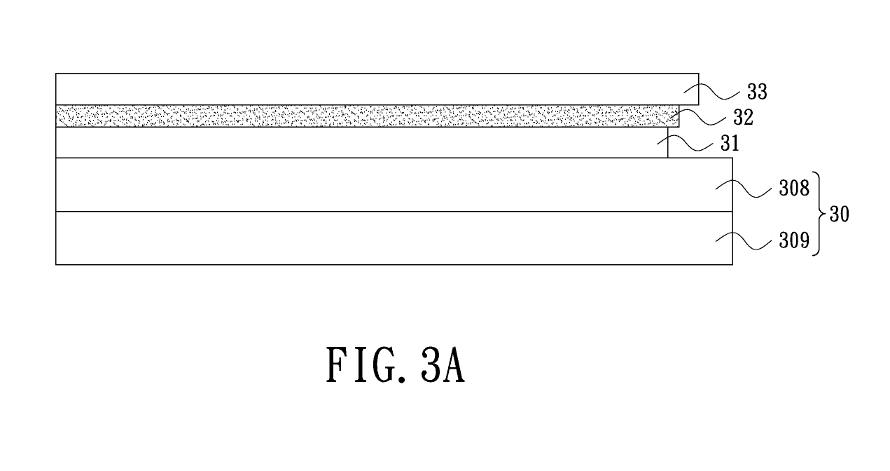

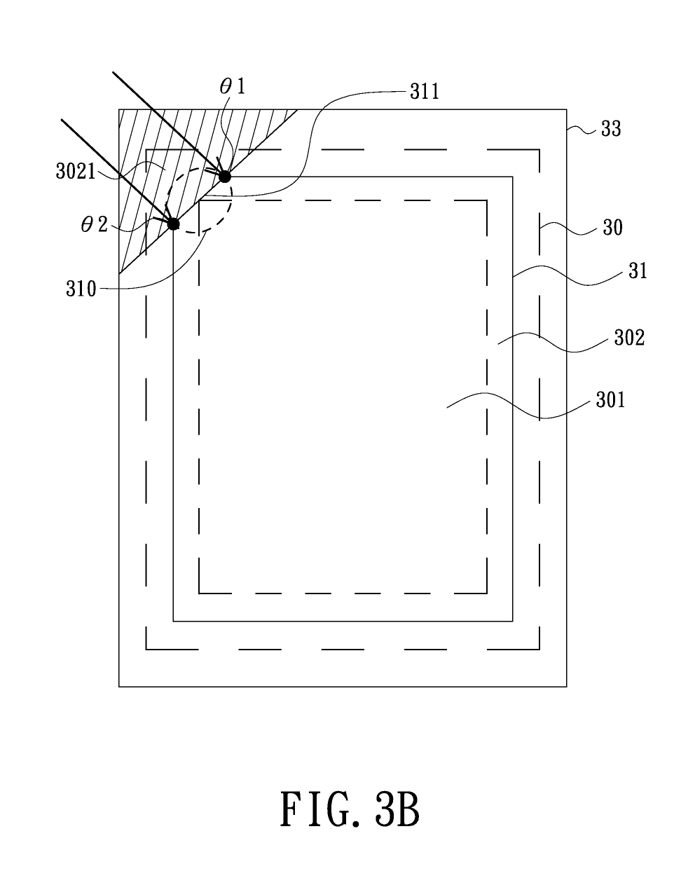

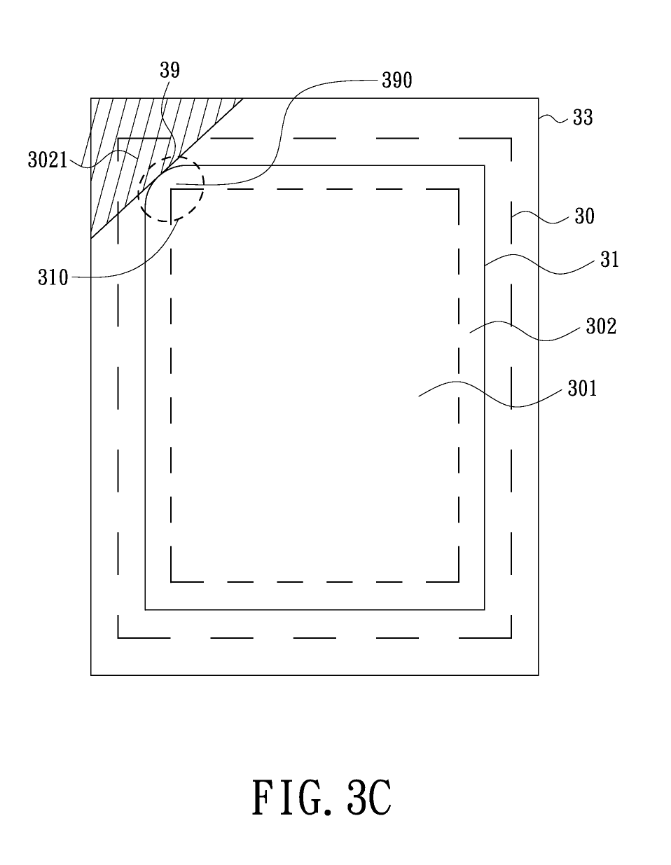

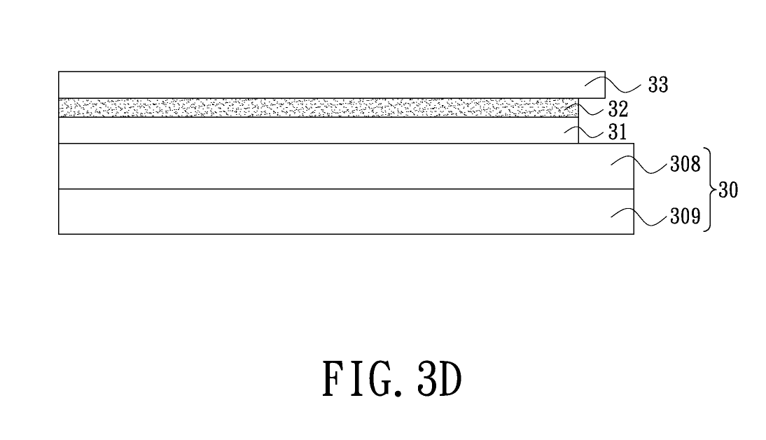

In order to solve the above problems, the shape of the polarizing sheet is modified according to the present invention. FIG. 3A is a cross-sectional view schematically illustrating an embodiment of a display device according to the present invention. FIG. 3B is a top view schematically illustrating an embodiment of the display device of the present invention as shown in FIG. 3A. Referring to FIG. 3A, the display device includes a display panel 30, a polarizing sheet 31, a transparent adhesive layer 32 and a transparent protective layer 33. The display panel 30 includes a lower substrate 309 and an upper substrate 308 disposed above the lower substrate 309. The polarizing sheet 31 is attached onto a surface of the upper substrate 308. The transparent adhesive layer 32 covers a surface of the polarizing sheet 31 opposite to the upper substrate 308. The transparent protective layer 33 further covers the transparent adhesive layer 32. Area of the polarizing sheet 31 is smaller than that of the transparent protective plate 33. An edge of the transparent adhesive layer 32 extends beyond an edge of the polarizing sheet 31 and contracts from an edge of the transparent protective layer 33. Nevertheless, the edge of the transparent adhesive layer 32 can be aligned with the edge of the polarizing sheet 31 in an alternative embodiment, for example as shown in FIG. 3D.

Referring to FIG. 3B, an embodiment of the display device of the present invention as shown in FIG. 3A is illustrated. A corner of the polarizing sheet 31 has a linear cut corner 310. The display panel 30 includes a display region 301 and a peripheral region 302 surrounding the display region 301. A corner portion 3021 of the peripheral region 302 corresponds to the cut corner 310. In this embodiment, the cutting line 311 locates outside the display region 301, for example, the cutting line 311 is close to one of the vertices of the display region 301 so that the line 311 can be made long without affecting the function of the display region 301. The long cutting line 311 facilitates dispersion of the impact force of the dropped display device therealong, thereby preventing from concentration of the impact force at the vertex point of the polarizing sheet 31 as a peeling force undesirably causing the separation of the polarizing sheet 31 from the transparent protective layer 33. Furthermore, a corner portion of the transparent protective layer 33, corresponding to the cut corner 310 of the polarizing sheet 31, may protrude from an outer edge of the cut corner 310. In other words, the cut corner 310 of the polarizing sheet 31 contracts relative to the edge of the transparent protective layer 33, deforming effect would become less significant compared to prior art. In other words, the polarizing sheet 31 may resist to higher drop impact force compared to prior art. It is to be pointed out that, in the above embodiment, one cut corner 310 of the polarizing sheet 31 is illustrated for an exemplary purpose, but more than one corner of the polarizing sheet 31 can be optionally cut to ameliorate dropping damage.

FIG. 3C illustrates another embodiment of the display device of the present invention as shown in FIG. 3A, wherein the cut corner is an arc cut corner 39 so that the angles θ1 and θ2 resulting from the cutting line 311 as shown in FIG. 3B is removed. The arc cut corner 39 has good force-dispersing effect and high impact resistance so as to prevent the transparent protective layer and the polarizing sheet from being separated from each other instantaneously.

In summary, by modifying the configuration of the layered structure according to the present invention, the de-lamination and bubbling problems encountered by the conventional technology can be ameliorated. Furthermore, the resistance to peeling force differentiates significantly between a polarizing sheet with a cut corner and a polarizing sheet with an ordinary corner. For example, the resistance to peeling force may be improved up to about 33%. The present invention is adapted to any suitable display device. For example but not for limitation, the display panel 30 can be a touch sensitive display panel, such as a liquid crystal display panel with a touch control unit, a plasma display panel (PDP) with a touch control unit, an organic light emitting diode display (OLED display) panel with a touch control unit or an electrophoretic display (EPD) panel with a touch control unit. The transparent adhesive layer 32 can be made of optically clear adhesive, or a transparent adhesive film. The transparent protective layer 33 can be made of glass or acrylic. Desirably, the transparent protective layer 33 is made of protective material with relatively high hardness.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A display device, comprising:
a display panel;
a polarizing sheet attached onto a surface of the display panel;
a transparent adhesive layer overlying a surface of the polarizing sheet opposite to the surface of the display panel; and
a transparent protective layer attached to the polarizing sheet through the transparent adhesive layer, and having an area greater than the polarizing sheet;
wherein the polarizing sheet has at least one cut corner and the polarizing sheet is completely covered by the transparent protective layer.

2. The display device according to claim 1, wherein the display panel is a touch sensitive display panel.

3. The display device according to claim 1, wherein the transparent adhesive layer is made of optically clear adhesive.

4. The display device according to claim 1, wherein the transparent protective layer is made of glass or acrylic.

5. The display device according to claim 1, wherein the display panel has a display region and a peripheral region surrounding the display region, and the cut corner of the polarizing sheet spatially corresponds to a corner of the peripheral region, and the display region is completely covered by the polarizing sheet.

6. The display device according to claim 5, wherein the display panel comprises a lower substrate and an upper substrate disposed above the lower substrate, and the polarizing sheet is disposed on the upper substrate.

7. The display device according to claim 1, wherein the cut corner is a linear cut corner.

8. The display device according to claim 1, wherein the cut corner is an arc cut corner.

9. The display device according to claim 1, wherein an edge of the transparent adhesive layer extends beyond or aligned with an edge of the polarizing sheet, and the transparent adhesive layer contracts from an edge of the transparent protective layer.

10. The display device according to claim 1, wherein the transparent adhesive layer is a transparent adhesive film.

11. The display device according to claim 1, wherein a corner portion of the transparent protective layer, corresponding to the cut corner, protrudes from an outer edge of the cut corner.
